(19) United States
(12) Patent Application Publication
(10) Pub. No.: US 2010/0148657 A1
(43) Pub. Date: Jun. 17, 2010

(54) Plane light source

(75) Inventors: Yi-Ping Lin, Changhua County (TW); Jung-Yu Li, Taipei County (TW); Shih-Pu Chen, Hsinchu City (TW); Po-Hung Wang, Kaohsiung County (TW); Yen-I Chou, Hsinchu City (TW); Ming-Chung Liu, Taoyuan County (TW)

Correspondence Address: J C PATENTS, 4 VENTURE, SUITE 250, IRVINE, CA, 92618, US

(73) Assignee: Industrial Technology Research Institute, Hsinchu (TW)

(21) Appl. No.: 12/322,810

(22) Filed: Feb. 5, 2009

(30) Foreign Application Priority Data
Dec. 11, 2008 (TW) 97148267

(51) Int. Cl. H01J 1/62

(52) U.S. Cl. 313/484

(57) ABSTRACT

A plane light source is provided. The plane light source includes an anode layer, a cathode layer, a discharging gas, and at least one fluorescent layer. The discharging gas is between the anode layer and the cathode layer. The fluorescent layer is disposed on the anode layer and located between the anode layer and the cathode layer. In the plane light source, electrons is activated by discharge of the discharging gas and emitted from the cathode layer. The fluorescent layer is adapted for emitting a light when being bombarded by the electrons.

### CROSS-REFERENCE TO RELATED APPLICATION

This application claims the priority benefit of Taiwan application serial no. 97148267, filed Dec. 11, 2008. The entirety of the above-mentioned patent application is hereby incorporated by reference herein and made a part of this specification.

### BACKGROUND OF THE INVENTION

1. Field of the Invention

The present invention generally relates to a plane light source, and more particularly, to a plane light source adapted for providing a surface light source or displaying a static image.

2. Description of Related Art

There are typically two light emitting mechanisms adopted by current commercially produced light sources or display devices. One is the gas discharge light emitting mechanism, and the other one is the field emission light emitting mechanism. Generally, the gas discharge light emitting mechanism is mainly applied in plasma display panels (PDP) or gas discharge lamps. In accordance with the gas discharge light emitting mechanism, an electric field is generated between a cathode and an anode. The electric field ionizes the gas filled in a discharging cavity. Electrons bombard the gas, thus causing transitions of electrons and producing an ultraviolet (UV) light. Meanwhile, fluorescent distributed in the discharging cavity absorb the UV light and emit a visible light. As to the field emission light emitting mechanism, it is usually applied in carbon nanotube field emission displays (CNT-FED). In accordance with the field emission light emitting mechanism, in an ultrahigh vacuum (UHV) environment (<10⁻⁶ Torr), electron emitters made of nano carbon materials are provided on the cathode. The electron emitters are featured with a microstructure having a high aspect ratio. Such a microstructure helps electrons overcoming the work function of the cathode and leaving the cathode. In such a CNT-FED, the anode made of indium tin oxide (ITO) is provided with fluorescent thereon. A high electric field distributed between the cathode and the anode motivates the electrons to be emitted from CNT of the cathode. The high electric field guides the electrons directly bombarding the fluorescent on the anode, and therefore the fluorescent emit the visible light.

However, both the foregoing two light emitting mechanisms have their own disadvantages. For example, the UV light is a prerequisite of the gas discharge light emitting mechanism, and thereafter the UV light can be used to excite the fluorescent to emit the visible light. As such, the gas discharge light emitting mechanism is featured with high power consumption, and the power consumption would be more when a plasma is required in addition. Further, the field emission light emitting mechanism requires the electron emitters to be uniformly provided on the cathode. Unfortunately, technologies for producing such a cathode having a large area are not yet well established. Therefore, the uniformity of the electron emitters and the yield of the cathode become a bottleneck restricting the application of the field emission light emitting mechanism. Furthermore, in a field emission light emitting unit, the space from the cathode to the anode must be precisely controlled, and the packaging operation under the UHV condition is relatively difficult, so that the production cost is relatively high.

### SUMMARY OF THE INVENTION

Accordingly, the present invention is directed to provide a plane light source for providing a surface light source, or displaying a static image.

The present invention provides a plane light source. The plane light source includes an anode layer, a cathode layer, a discharging gas, and at least one fluorescent layer. The discharging gas is distributed between the anode layer and the cathode layer. The fluorescent layer is disposed on the anode layer, and is located between the anode layer and the cathode layer. In the plane light source, electrons can be activated by gas discharge of the discharging gas and emitted from the cathode layer. The fluorescent layer is adapted for emitting a light when being bombarded by the electrons.

Accordingly, the fluorescent layer of the present invention can be prepared with a single fluorescent material, or alternatively prepared with a combination of a plurality of different fluorescent materials. As such, the plane light source of the present invention can be adapted as desired to serve as a surface light source, or to display a static image (e.g., a monochrome image, a color image, or a greyscale image).

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is cross-sectional view of a plane light source according to a first embodiment of the present invention.

FIG. 2 is cross-sectional view of a plane light source according to a second embodiment of the present invention.

FIG. 3 is a diagram illustrating a relationship between the distribution density of the fluorescent pattern and corresponding reflected greyscale.

FIG. 4A is a schematic diagram illustrating a monochromatic fluorescent. pattern.

FIG. 4B is a schematic diagram illustrating a monochromatic fluorescent greyscale pattern.

FIG. 5A is a schematic diagram illustrating a color fluorescent pattern constituted of a plurality of monochromatic fluorescent patterns.

FIG. 5B is a schematic diagram illustrating a color fluorescent greyscale pattern constituted of a plurality of monochromatic fluorescent greyscale patterns.

FIG. 6 illustrates CIE coordinates of white light emitted by the plane light source under different driving voltages.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

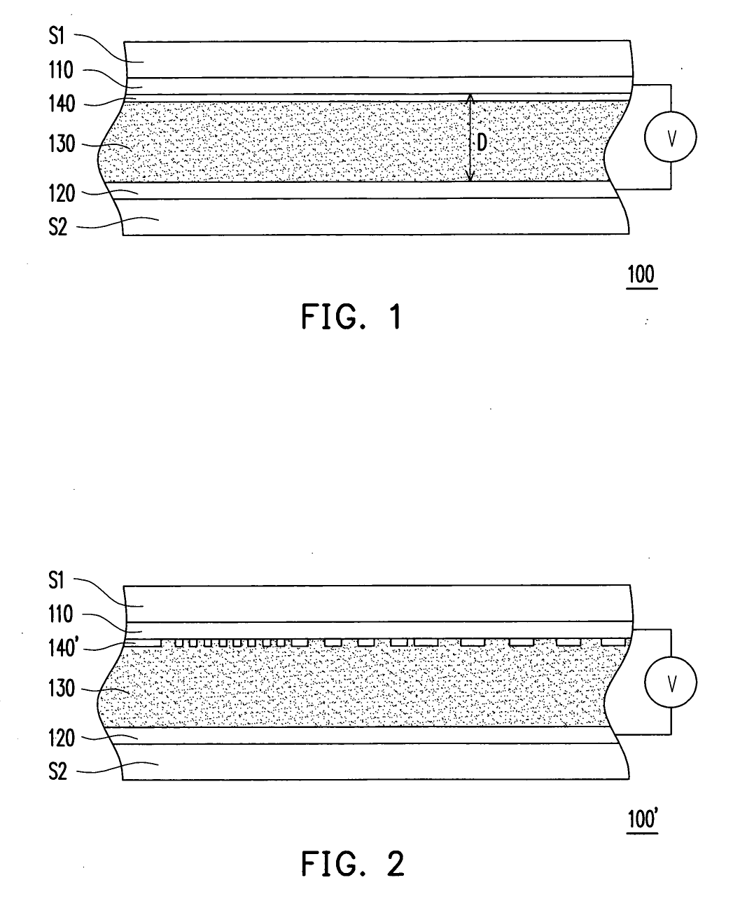

FIG. 1 is cross-sectional view of a plane light source according to a first embodiment of the present invention. Referring to FIG. 1, the present invention provides a plane light source 100. The plane light source 100 includes an anode layer 110, a cathode layer 120, a discharging gas 130 disposed between the anode layer 110 and the cathode layer 120, and at least one fluorescent layer 140 disposed on the anode layer 110. The fluorescent layer 140 is located between the anode layer 110 and the cathode layer 120. When a driving voltage V is applied between the anode layer 110 and the cathode layer 120, electrons can be activated and emitted from the cathode layer 120 by a gas discharge of the discharging gas 130. The fluorescent layer 140 is bombarded by the electrons so as to emit light. As shown in FIG. 1, both of the anode layer 110 and the cathode layer 120 are plane electrodes, which can be conveniently fabricated. The fluorescent layer 140 covers the entirety of the anode layer 110. In such a way, the plane light source provides a surface light source when the fluorescent layer 140 is bombarded by the electrons.

In the present embodiment, the anode layer 110 of the plane light source 100 is formed on a surface of a first substrate S1, and the cathode layer 120 is formed on a surface of a second substrate S2. The first substrate SI and the second substrate S2 are bonded through a sealant (not shown in the drawings) so as to configure a cavity. The cavity can be polygon shaped, round shaped, oval shaped, or any other applicable shape. As shown in FIG. 1, after the first substrate S1 and the second substrate S2 are bonded, the anode layer 110, the cathode layer 120, the discharging gas 130, and the fluorescent layer 140 are all accommodated in the cavity. Generally, a distance D from the anode layer 110 to the cathode layer 120 is effectively controlled by controlling a distance from the first substrate S1 to the second substrate S2.

In the present embodiment, the anode layer 110 is a transparent electrode layer. The anode layer 110 is made of indium tin oxide (ITO), indium zinc oxide (IZO), or other transparent conductive materials, for example. The cathode layer 120 is a reflective electrode layer. The cathode layer 120 is made of a metal material, for example. However, the present invention does not restrict the anode layer 110 to be necessarily a transparent electrode layer, and does not restrict the cathode layer 120 to be necessarily a reflective electrode layer. One ordinary skilled in the art can select suitable materials for preparing the anode layer 110 and the cathode layer 120 in accordance with the spirit of the present invention and the practical demand for the plane light source 100. For example, the anode layer 110 and the cathode layer 120 can also be both made of transparent electrode layers, so that the light is allowed to be transmitted from the first substrate SI and the second substrate S2.

It should be noted that the discharging gas 120 of the present embodiment could be inert gas or air. Specifically, the discharging gas can be helium (He), Neon (Ne), Argon (Ar), Krypton (Kr), Xenon (Xe), Hydrogen (H₂), or carbon dioxide (CO₂). Generally, a pressure produced by the discharging gas 130 in the cavity may be controlled within the range from 10⁻³ to 10 torr. The inside of the plane light source 100 is not maintained under an ultra high vacuum (UHV) condition, the plane light source 100 is not required to be packaged in under UHV condition. Therefore, the fabrication of the plane light source 100 is relatively simple.

Further, in order to active the electrons for emitting from the cathode layer 120, a secondary electron source material layer can be optionally provided on the cathode layer 120. The secondary electron source material layer is made of magnesium oxide (MgO), terbium oxide (Tb₂O₃), Lanthanun oxide (La₂O₃), or cerium oxide (CeO₂). Moreover, in order to active the electrons for emitting from the cathode layer 120, a nano carbon layer or a zinc oxide (ZnO) layer can be optionally provided on the cathode layer 120.

### Second Embodiment

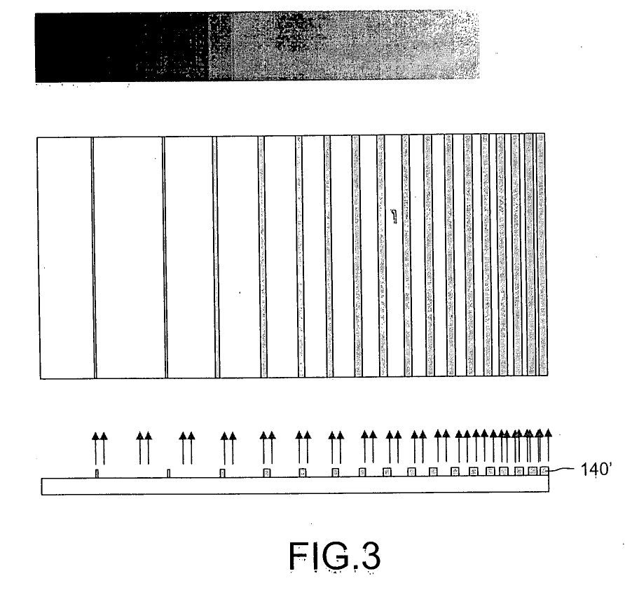

FIG. 2 is cross-sectional view of a plane light source according to a second embodiment of the present invention. Referring to FIGS. 1 and 2, the present embodiment of the present invention provides a plane light source 100′ which is similar to the plane light source 100 of the first embodiment, except that the plane light source 100′ includes a patterned fluorescent pattern 140′, and the fluorescent pattern 140′ covers only a part of the anode layer 110.

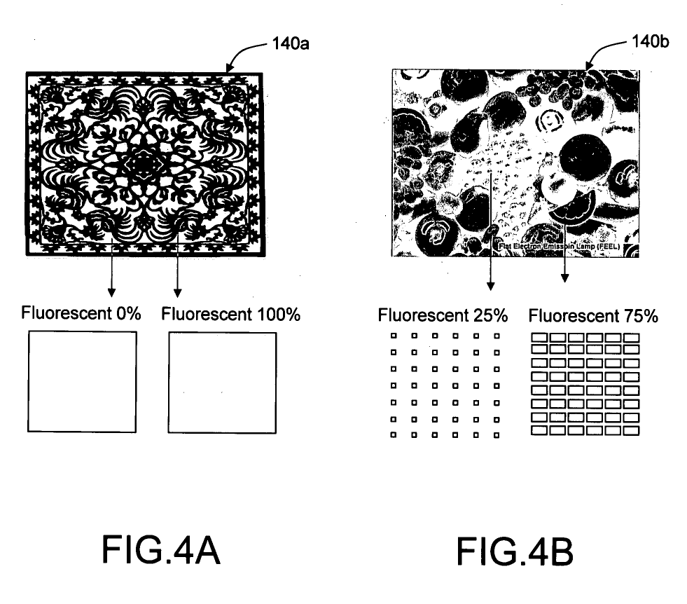

As clearly shown in FIG. 2, the plane light source 100′ is capable of displaying a static image, and the static image displayed by the plane light source 100′ is determined by a distribution of the fluorescent pattern 140′. FIGS. 3, 4A, 4B, 5A, and 5B will be referred below for further illustrating the distribution of the fluorescent pattern 140′.

FIG. 3 is a diagram illustrating a relationship between the distribution density of the fluorescent pattern and corresponding reflected greyscale. Referring to FIG. 3, the greyscale is presented higher at where the fluorescent pattern 140′ is distributed denser. On the contrary, the greyscale is presented lower at where the fluorescent pattern 140′ is distributed less dense. As such, when a certain area is completely covered by the fluorescent pattern 140′, the greyscale corresponding to the certain area is the highest greyscale, and when a certain area is completely uncovered by the fluorescent pattern 140′, the greyscale corresponding to the certain area is the lowest greyscale.

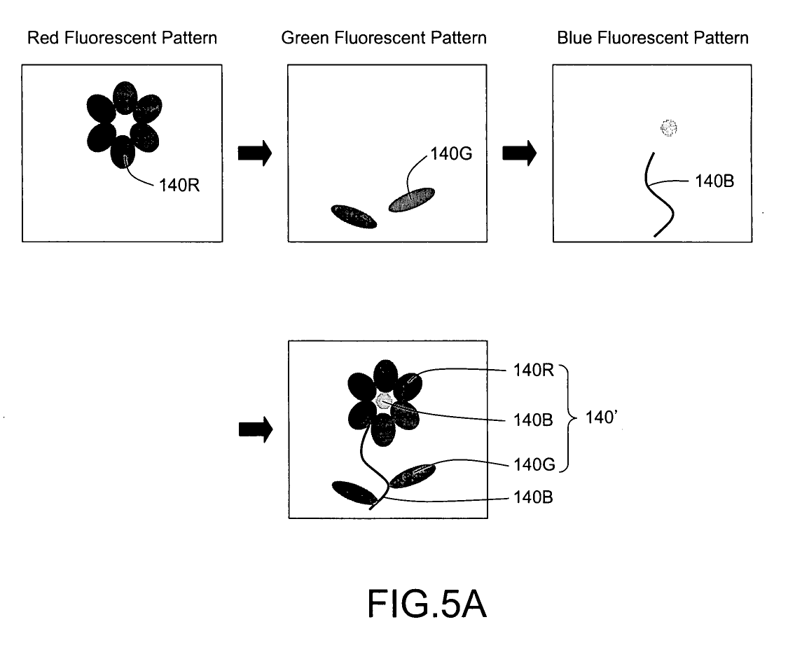

FIG. 4A is a schematic diagram illustrating a monochromatic fluorescent pattern. Referring to FIG. 4A, the dark area indicates the area completely covered by the fluorescent pattern 140a, while the blank area indicates the area uncovered by the fluorescent pattern 140a. When the fluorescent pattern 140a of FIG. 4A is applied in the plane light source 100′ of FIG. 2, the plane light source 100′ is capable of displaying a monochromatic image corresponding to the fluorescent pattern 140a when being driven.

FIG. 4B is a schematic diagram illustrating a monochromatic fluorescent greyscale pattern. Referring to FIG. 4B, the blank area indicates the area uncovered by the fluorescent greyscale pattern 140b, while the rest area shown in FIG. 4B is covered by the fluorescent greyscale pattern 140b which is either dense or less dense. When the fluorescent greyscale pattern 140b of FIG. 4B is applied in the plane light source 100′ of FIG. 2, the plane light source 100′ is capable of displaying a monochromatic greyscale image corresponding to the fluorescent greyscale pattern 140b when being driven.

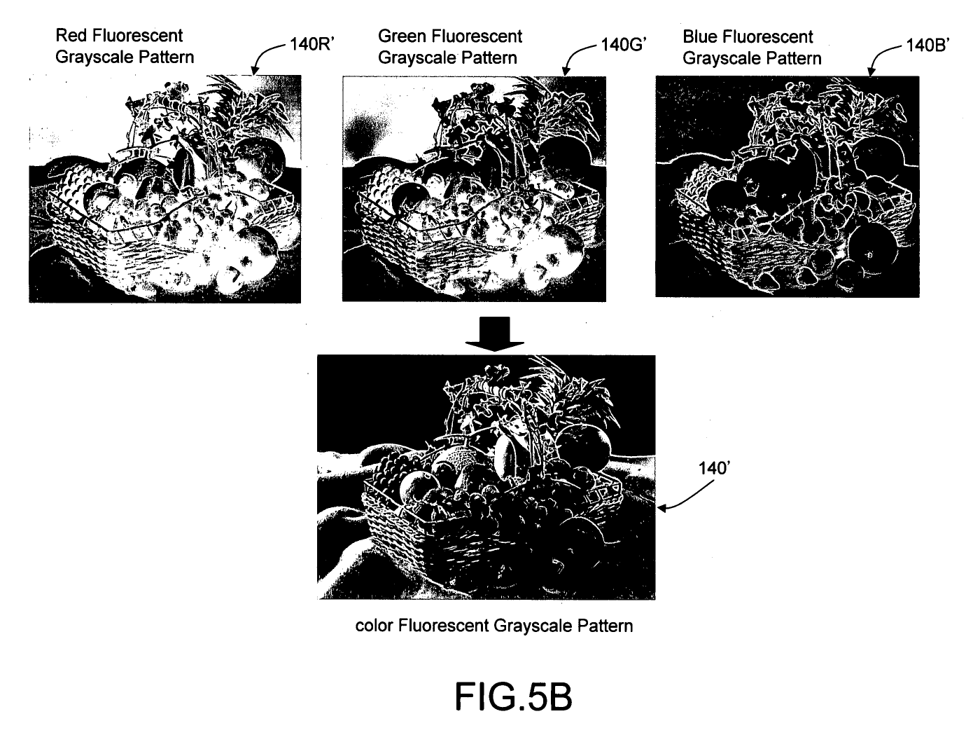

FIG. 5A is a schematic diagram illustrating a color fluorescent pattern constituted of a plurality of monochromatic fluorescent patterns. Referring to FIG. 5A, the fluorescent pattern 140′ is composed of a plurality of monochromatic fluorescent patterns 140R, 140G, and 140B. When being bombarded by electrons, the monochromatic fluorescent patterns 140R, 140G, and 140B are adapted for emitting different monochromatic lights, respectively. For example, the monochromatic fluorescent pattern 140R is a red fluorescent pattern, the monochromatic fluorescent pattern 140G is a green fluorescent pattern, and the monochromatic fluorescent pattern 140B is a blue fluorescent pattern. Of course, materials for fabricating the monochromatic fluorescent patterns 140R, 140G, and 140B are not restricted by the present invention.

It should be noted that the monochromatic fluorescent patterns 140R, 140G, and 140B can be either overlapped one another or non-overlapped at all according to the image to be displayed. What is shown in FIG. 5A illustrates the situation that the monochromatic fluorescent patterns 140R, 140G, and 140B are non-overlapped each other.

FIG. 5B is a schematic diagram illustrating a color fluorescent greyscale pattern constituted of a plurality of monochromatic fluorescent greyscale patterns. Referring to FIG. 5B, the fluorescent pattern 140′ is composed of a plurality of monochromatic fluorescent greyscale patterns 140R′, 140G′, and 140B′. When being bombarded by electrons, the monochromatic fluorescent greyscale patterns 140R′, 140G′, and 140B′ are adapted for emitting different monochromatic lights, respectively. For example, the monochromatic fluorescent greyscale pattern 140R′ is a red fluorescent greyscale pattern, the monochromatic fluorescent greyscale pattern 140G′ is a green fluorescent greyscale pattern, and the monochromatic fluorescent greyscale pattern 140B′ is a blue fluorescent greyscale pattern. Of course, materials for fabricating the monochromatic fluorescent greyscale patterns 140R′, 140G′, and 140B′ are not restricted by the present invention.

It should be noted that the monochromatic fluorescent greyscale patterns 140R′, 140G′, and 140B′ can be either overlapped one another or non-overlapped at all according to the image to be displayed. What is shown in FIG. 5B illustrates the situation that the monochromatic fluorescent greyscale patterns 140R′, 140G′, and 140B′ are non-overlapped each other.

As shown in FIGS. 4A, 4B, 5A, and 5B, the plane light source 100′ can be customerized in accordance with the variation of the products or the demand of the users.

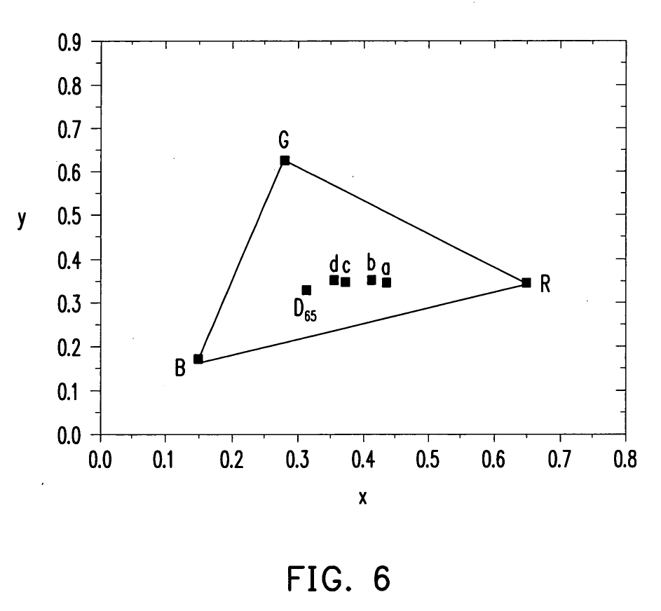

FIG. 6 illustrates CIE coordinates of white light emitted by the plane light source under different driving voltages. Referring to FIG. 6, the CIE coordinates of the white light emitted by the plane light source 100 or 100′ can be varied by adjusting the driving voltage. As shown in FIG. 6, point D₆₅ indicates CIE coordinates (0.3127, 0.3290) of the D₆₅ standard light source, while CIE coordinates of point a, point b, point c and point d are (0.4325, 0.3465), (0.4134, 0.3512), (0.3712, 0.3476), and (0.3573, 0.3500), respectively. As show in FIG. 6, the CIE coordinates of the white light provided by the plane light source 100 or 100′ in accordance with the variation of the driving voltage. Therefore, one ordinary skilled in the art may modulate the CIE coordinates of the white light provided by the plane light source 100 or 100′ according to the relationship disclosed in FIG. 6.

In summary, the plane light source provided by the present invention can be widely applied in color boards, advertising boards, indoor lighting scenarios, and outdoor lighting scenarios. According to the present invention, different displaying effects can be achieved by applying different distribution modes of different fluorescent layers, thus the competitive power of the plane light source in the customerizing market can be correspondingly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A plane light source, comprising:
an anode layer;
a cathode layer;
a discharging gas between the anode layer and the cathode layer; and
at least one fluorescent layer disposed on the anode layer and located between the anode layer and the cathode layer, wherein electrons are activated by discharge of the discharging gas and emitted from the cathode layer, and the fluorescent layer is adapted for emitting a light when being bombarded by the electrons.

2. The plane light source according to claim 1, wherein the anode layer is a transparent electrode layer.

3. The plane light source according to claim 1, wherein the cathode is a reflective electrode layer.

4. The plane light source according to claim 1 further comprising a secondary electron source material layer covering on the cathode layer.

5. The plane light source according to claim 4, wherein the secondary electron source material layer comprises magnesium oxide (MgO), terbium oxide (Tb₂O₃), Lanthanun oxide (La₂O₃), or cerium oxide (CeO₂).

6. The plane light source according to claim 1, wherein the discharging gas comprises an inert gas or air.

7. The plane light source according to claim 1, wherein the discharging gas comprises helium (He), Neon (Ne), Argon (Ar), Krypton (Kr), Xenon (Xe), Hydrogen (H₂), or carbon dioxide (CO₂).

8. The plane light source according to claim 1, wherein a pressure of the discharging gas is within a range from 10⁻³ to 10 torr.

9. The plane light source according to claim 1, wherein the fluorescent layer completely covers the entirety of the anode layer.

10. The plane light source according to claim 1, wherein the fluorescent layer is a fluorescent pattern covering a part of the anode layer.

11. The plane light source according to claim 10, wherein the fluorescent pattern comprises a monochromatic fluorescent pattern.

12. The plane light source according to claim 10, wherein the fluorescent pattern comprises a plurality of monochromatic fluorescent patterns, and when being bombarded by electrons, the monochromatic fluorescent patterns are adapted for emitting different monochromatic lights, respectively.

13. The plane light source according to claim 12, wherein the monochromatic fluorescent patterns are overlapped one another.

14. The plane light source according to claim 12, wherein the monochromatic fluorescent patterns are non-overlapped each other.

15. The plane light source according to claim 1, wherein the fluorescent pattern comprises a monochromatic fluorescent greyscale pattern.

16. The plane light source according to claim 1, wherein the fluorescent pattern comprises a plurality of monochromatic fluorescent greyscale patterns, and when being bombarded by electrons, the monochromatic fluorescent greyscale patterns are adapted for emitting different monochromatic lights, respectively.

17. The plane light source according to claim 16, wherein the monochromatic fluorescent greyscale patterns are overlapped one another.

18. The plane light source according to claim 16, wherein the monochromatic fluorescent greyscale patterns are non-overlapped each other.

19. The plane light source according to claim 1 further comprising a nano-carbon layer disposed on the cathode layer.

20. The plane light source according to claim 1 further comprising a zinc oxide (ZnO) layer disposed on the cathode layer.

21. The plane light source according to claim 1 further comprising a cavity, wherein the anode layer, the cathode layer, the discharging gas, and the fluorescent layer are accommodated in the cavity.
